(19) United States
(12) Patent Application Publication
(10) Pub. No.: US 2018/0167226 A1
(43) Pub. Date: Jun. 14, 2018

(54) Method for visualizing and connecting concurrent website visitors as a universal communication layer across websites on the internet

(71) Applicant: Matz Niklaz Loennqvist, Stockholm (SE)

(72) Inventor: Matz Niklaz Loennqvist, Stockholm (SE)

(21) Appl. No.: 15/834,115

(22) Filed: Dec. 7, 2017

Related U.S. Application Data
(60) Provisional application No. 62/430,976, filed on Dec. 7, 2016.

(51) Int. Cl. H04L 12/18; G06F 17/30

(52) U.S. Cl. CPC H04L 12/1813; G06F 17/30867

(57) ABSTRACT

This patent application presents a novel method for connecting users in a detached networking layer, wherein users are able to interact and exchange freely, and new avenues of exploration are dynamically surfaced to users and third parties, filterable through a variety of factors. The application also describes a method for extending the invention onto third parties, thereby allowing them to create a customized, local version of the method. A variety of components, key to the operation and interaction of the method are described and complemented with examples.

### BACKGROUND

The internet is everywhere, simultaneously connecting billions of people worldwide. Yet, paradoxically, browsing the internet today is a solitary experience. The websites you visit may have thousands of concurrent visitors, but the user and the site alone seem to exist in a vacuum. In cases where the website does not provide a local platform for communication, such as a chat platform or a commenting system, the browsing visitor has no means of interacting with the other people visiting the same website at the same time. This invention connects people concurrently using the same website, if they so desire, without any changes needed for the website.

### INVENTION SUMMARY

The invention described herein, is a novel method of creating rooms on top of websites wherein concurrent website visitors can opt to interact with each other, in a simulated “room” environment. Using the popularity and the amount of activity in each of these rooms, the invention is able to generate lists ranked and sorted by a variety of factors such as amount of users sessions during a specific set of time. Further refinement is possible by further collating output data against a variety of factors, such as user location.

Further extending the capabilities of the invention, it is also available for third-party implementation. Through a third-party choosing to implement the method locally (such as on a website, or in a mobile application), the method and the broader invention become available to all users of that third-party product or domain; whether or not they are pre-existing users of the first party service. Local implementation allows the third-party website to create, parse and tailor list rankings based visitor rooms of their service, such as outputting a list of subpages ranked by user popularity based on the third-party website root URL.

### BRIEF DESCRIPTION OF THE DRAWINGS

FIG. 1 illustrates a model for social interaction dubbed “websites visitors room” created for every unique root URL that is visited by a user, in accordance with an embodiment.

FIG. 2 illustrates what a website visitor room consists of and how it operates, in accordance with an embodiment of the invention.

FIG. 3 illustrates the assembled listing of links to websites with existing rooms created by users visiting websites, in accordance with an embodiment of the invention.

FIG. 4 demonstrates two methods of distributing the assembled listing of websites, in accordance with an embodiment of the invention.

FIG. 5 illustrates how the service makes the room and the listing of websites available for third-party embedding, in accordance with an embodiment of the invention.

FIG. 6 illustrates how the service makes the invention available to be locally implemented on third-party websites, in accordance with an embodiment of the invention.

FIG. 7 illustrates how the components connect and interact to form the method architecture, in accordance with an embodiment of the invention.

FIG. 8 illustrates how the components connect and interact to form the system, when implemented on a third-party product or service, in accordance with an embodiment of the invention.

The figures depict various embodiments of the disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

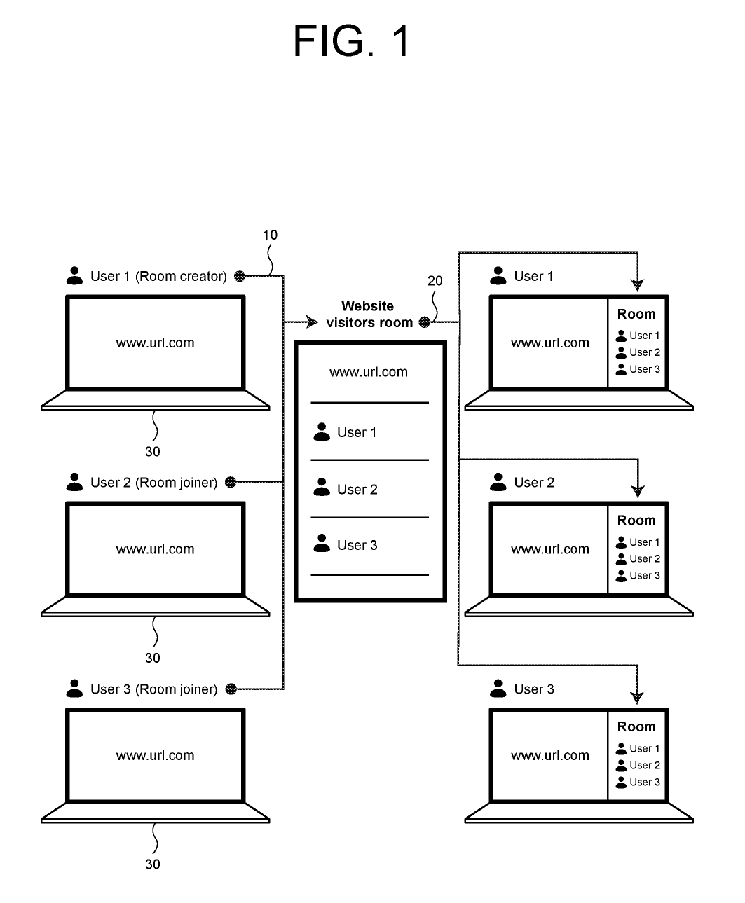

FIG. 1 illustrates a model for social interaction dubbed “websites visitor room” or room created for every unique URL that is visited by a user (10). This room is then distributed (20) to all users that are visiting that same website at the same time. The room can be implemented on any type of networked device or tool (30) that users connect to websites with.

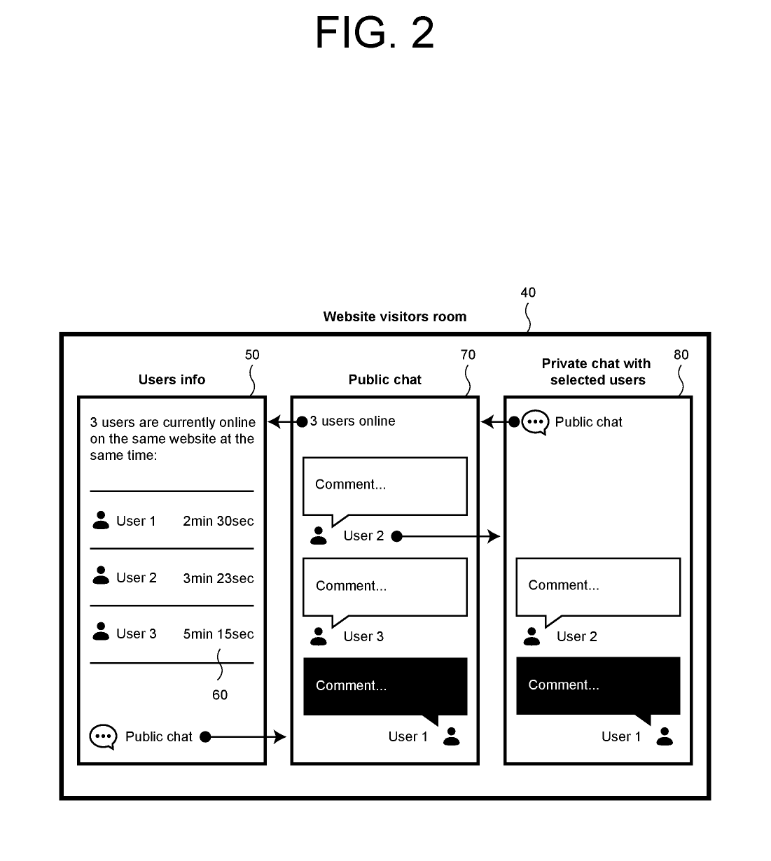

FIG. 2 illustrates what a website visitors room consists of and how it operates (40). This room model allows a user to see and interact with all other users currently interacting with the same website. (50), This implementation also allows the user to see different information, such as the length of time that users have been visiting the website (60). The room provides a public chat (70) within which you can interact and communicate with all other users in the room. A user is also able to start a private chat (80), in which to chat privately with either one or several selected users.

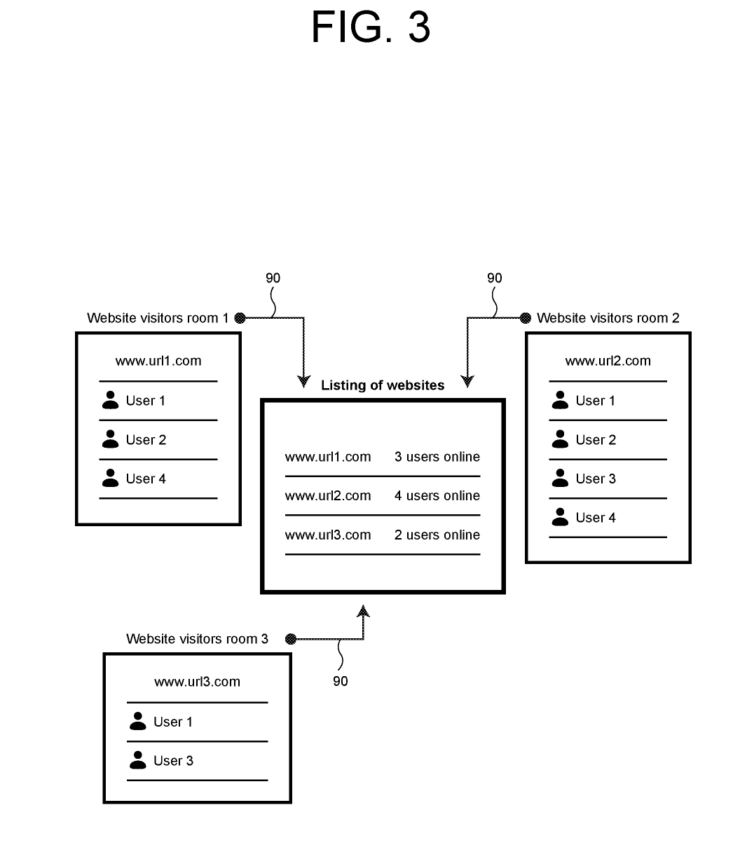

FIG. 3 illustrates the assembled listing of links to websites with existing rooms created by users visiting those websites (90).

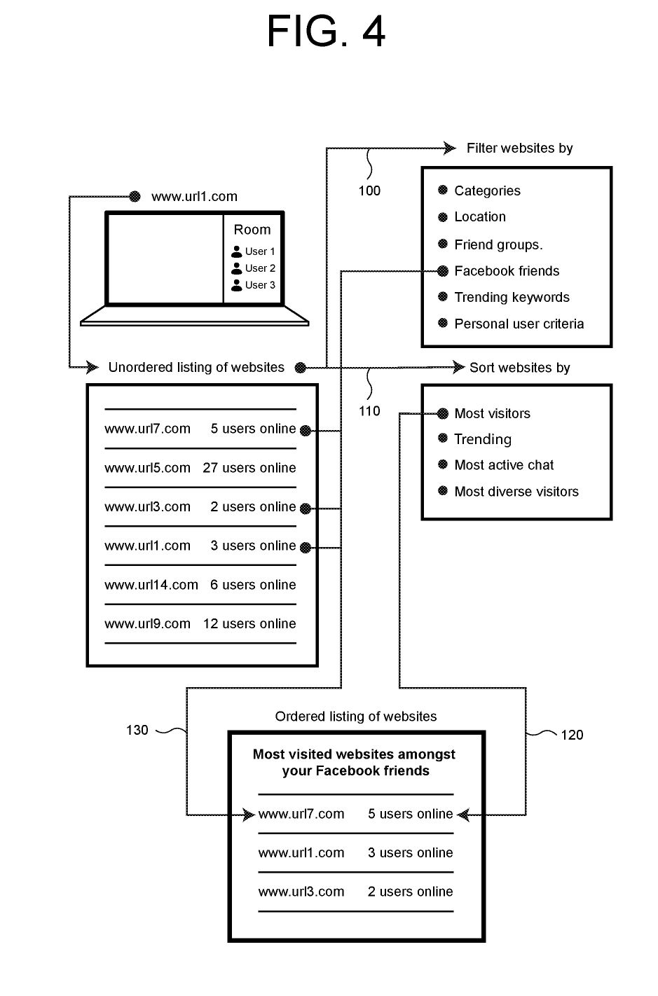

FIG. 4 demonstrates two methods of distributing the assembled listing of websites, by various techniques and parameters of filtering (100) and sorting (110).

The filtering system provides, but is not limited to, 6 primary modes of filtering (100):

1. Categories, retrieved dynamically from the meta tags of the websites.

2. Geographic location, retrieved through the IP address of the website.

3. Friends, selected user/users.

4. Websites by retrieving friends to user from any type of third-party platform like e.g. Facebook connect.

5. Personal user criteria, such as users determined by age, sex, interests, political views, etc.

6. Trending keywords in system rooms or on system websites.

The sorting system provides, but is not limited to, 4 chief modes of sorting (110):

1. Room and or websites ranked ranked by visitor count (over a set time period) and active users.

2. “Trending rooms” rated by user growth over time.

3. Most active chats, quantified by amount of messages sent over time period.

4. Most diverse users, based on age, sex, location, interests, political views, etc.

Moreover, these filtering and ranking methods could be combined, such as outputting a compound list sorted by: Most visited websites (120) amongst your Facebook friends (130).

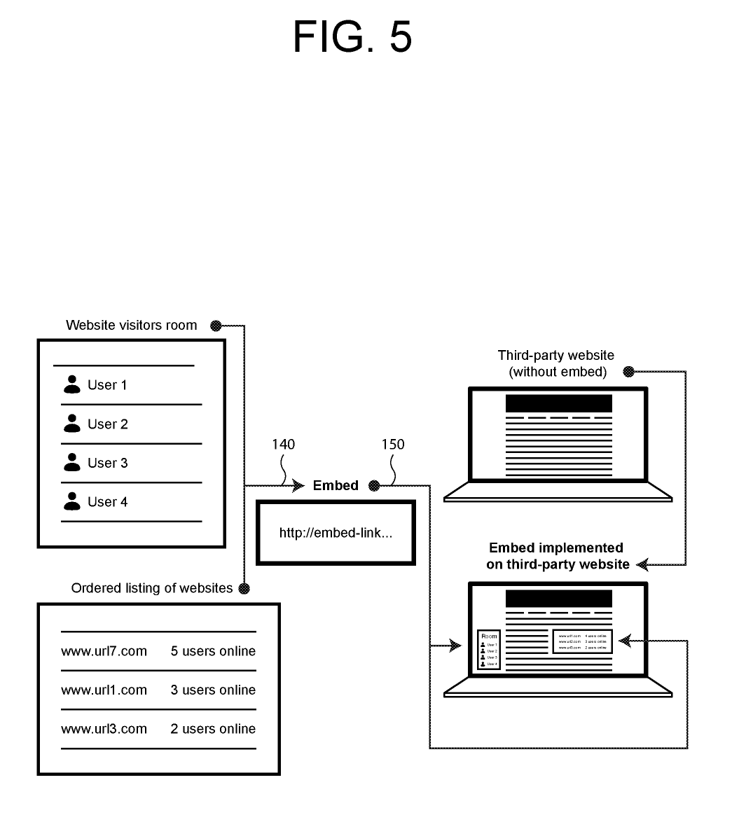

FIG. 5 illustrates how the service makes the room (together with all features) and/or listing of websites (together with all features) available for third-party websites to implement from our website/server (140) embedded on the third-party website (150).

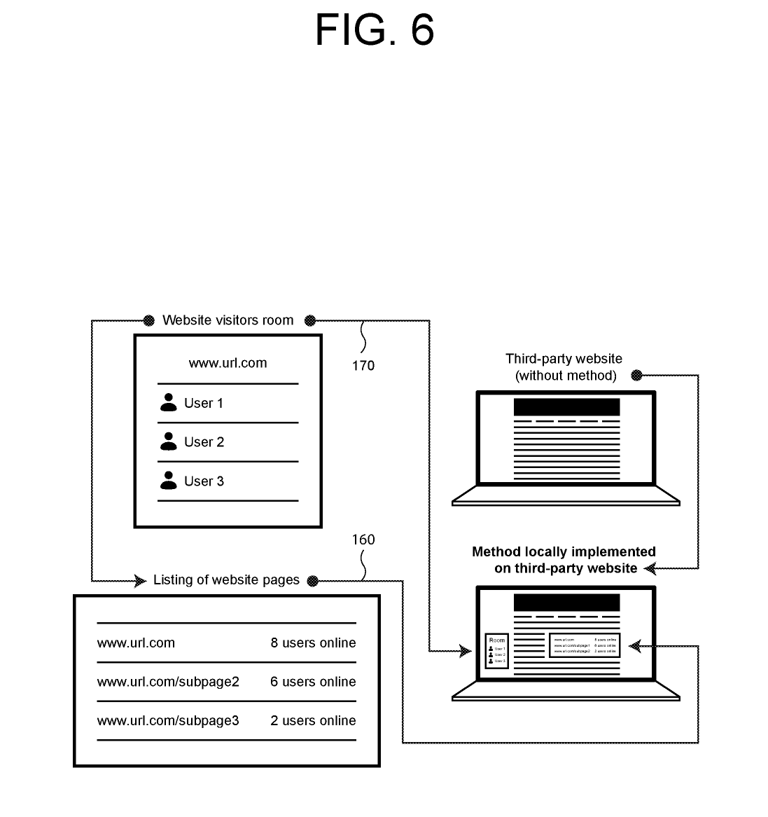

FIG. 6 illustrates how the service makes the method and the invention described herein, available to be locally implemented on third-party websites. By locally hosting an implementation of the method, the third-party website can create a locally ranked listing of website pages (160) and connect anyone who visits the third-party website simultaneously, including non-users (170).

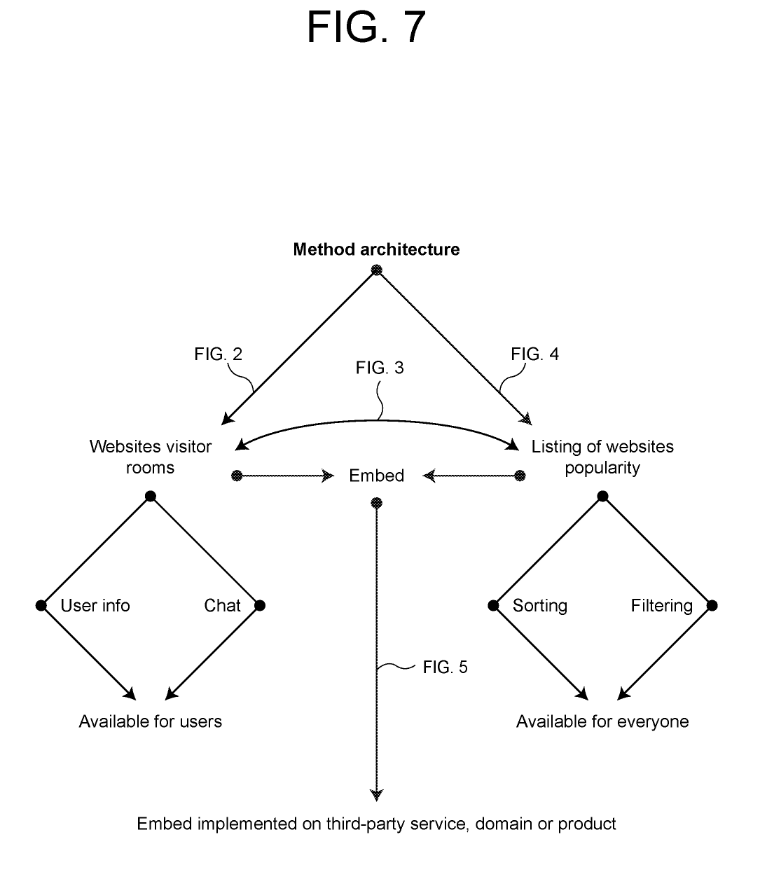

FIG. 7 illustrates how the components connect and interact, forming the method architecture. In its core, the method is an output of website visitors rooms (FIG. 2) and a ranked listing of websites (FIG. 3) based on data from the website visitors rooms (FIG. 4). These 2 outputs can also be exported through embedding, for third-party implementation (FIG. 5).

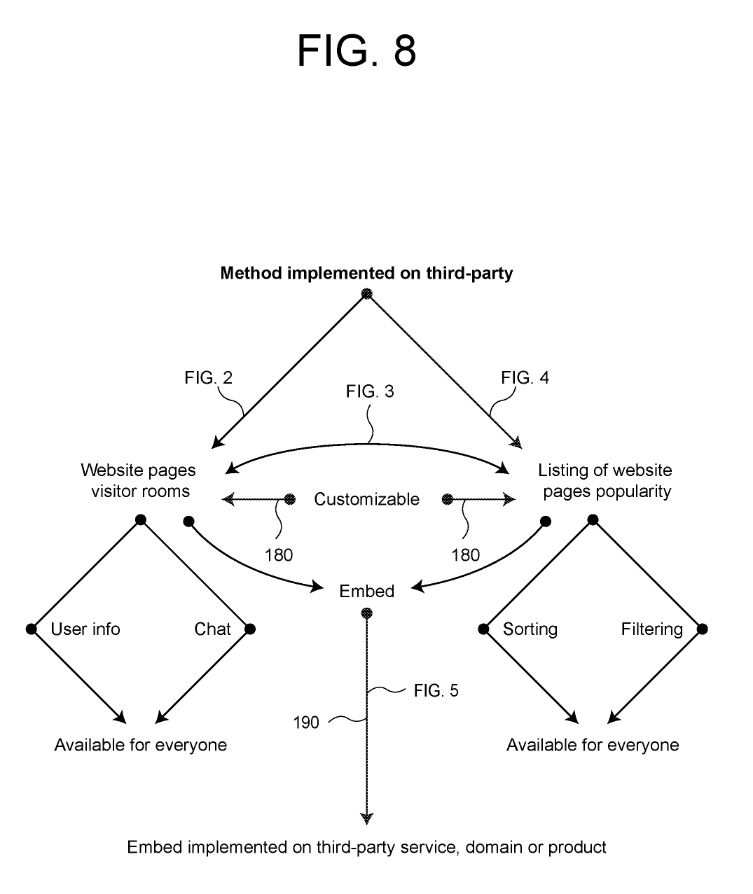

FIG. 8 illustrates how the components connect and correlate to form the method architecture, when implemented on third-party product or service (FIG. 6). Herein, the method is an output of local website visitor rooms based on the root URL. As well as listings of local website pages popularity.

One embodiment of the method and invention, provides a means of customizing its outward appearance and functionality to users and third parties (180). This means that third parties are provided with a set of options to tweak and customize the invention to their will, should they wish. E.G. a newspaper publication could tweak visual elements such as color schemes and typography to match their visual profile, thereby providing a greater sense of integration between the invention and the third-party domain. In granting third parties the ability to tailor the implementation of the room and generated lists we provide increased brand value for the third-party.

After being implemented by a third party, this third party's implementation becomes available to other third parties allowing them to connect and locally embed the same implementation on their own service or product. For example, a newspaper such as the Guardian could implement another third party's embed, such as the visitor room and/or listing of website pages from the New York Times on their homepage (www.theguardian.com). (190).

Listing of components that are included in the system:
Listing of users that are currently visiting, or previously have visited a given website.
Information about user duration on website.
Information about user interaction on website.
Public chat.
Private chat.
Voice recording.
Video recording.
New tab implementation.
Non-browser based implementation.
Smartphone implementation.
Third-party login (e.g. Facebook, Twitter, Google+ login).
Filtering listing of websites (further explanation above and in FIG. 4).
Sorting listing of websites (further explanation above and in FIG. 4).
Third-party implementation of method and system.
Customization options for third-party implementation.
Invite to a different page, private or selected chat link.
Add friends.
Grouping of selected users.
Predefined rooms, such as a lifestyle room on a newspaper's homepage.
Blocking certain category of websites or specific websites.
Blocking certain category of users or specific users.
Alert/Notification when any and/or specific users joins or interacts in chat room.
Specific user alerts when selected users interact in the system.
Suggested chats on third-party website based on keywords.
Suggested subpages to root URL based on room activity.
Room creation based on search parameters such as meta tags, user assigned categories or chat keywords.
Overarching rooms detached from URL based parent url resources room creation. e.g. politics room on all subpages of third-party website e.g. www.nytimes.com.
Overarching rooms based on uri parent path.
Ratio or time base non-unidirectional communication.
Time chat post limits hierarchy.
User moderators.
Support rooms.
Paywall rooms.

As a digital solution, the invention can be extended onto any device, platform or browser. But in its initial release, the invention is envisioned as being a browser extension that integrates into a user's browser. As well as a plugin that can be locally hosted by third-party websites.

The method is platform agnostic and has the ability to be used by any networked device with which you connect, interact or come in contact with. It could e.g. automatically connect a user with other users connected to a network.

The method and output of the platform can be harnessed by third parties in order to create a local implementation of the method. E.G. allowing a third-party to create a plugin to track the popularity of website pages based on the root URL.

Data outlining the flow and interaction of users on the platform can be used to create other products.

By applying and/or implementing the method you could create a service that aggregates and parses the user data collected from the method. This can be used to analyze and map user behaviour flow on websites for a variety of purposes—such as creating backend analytics or presenting users with new avenues for content exploration on the frontend. A simple implementation of the method could allow an implementer could dynamically surface the most popular content on their domain. E.G. a blog could display the most interesting articles of the blog by displaying what current and previous visitors have clicked on and the pages where users spend the majority of their time.

1. A system for Internet-based communication and exploration, wherein users simultaneously, while connected to said medium can choose to interact.

2. Referring to claim 1, where communication refers to a shared system of interaction between users.

3. Referring to claim 2, interaction refers to communication of other digitally transmissible data such as text, images, sounds, video and other sensory modes.

4. Referring to claim 1, medium may refer to a website or networked environment.

5. Referring to claim 1, exploration provides a means and a system of aggregating digital domains based on set criteria.

6. Referring to claim 5, set criteria may include but is not limited to e.g. website popularity, user communication, website location, user location, website categories and other user metadata as outlined in FIG. 4 of Detailed Description.

7. in reference to claim 1, where users refers to people employing the method.

8. Referring to claim 1, user choice refers to users opting to engage with one embodiment of the invention.

9. Referring to claim 1, wherein communication occurs within a host defined room environment.

10. Referring to claim 9, where host describes a participating user or third-party.
